(19) United States
(12) Patent Application Publication
(10) Pub. No.: US 2005/0129221 A1
(43) Pub. Date: Jun. 16, 2005

(54) Alerting of network-associated information associated with a telephone call

(76) Inventors: James E. Dickens, Ocoee, FL (US); Isaac D.M. White, Groveland, FL (US)

Correspondence Address: Scott P. Zimmerman, P.O. Box 3822, Cary, NC, 27519, US

(21) Appl. No.: 10/733,192

(22) Filed: Dec. 11, 2003

(51) Int. Cl. H04M 1/00; H04M 3/00

(52) U.S. Cl. 379/373.01

(57) ABSTRACT

Methods, systems, and devices are disclosed for alerting a subscriber of network-associated information upon receipt of a telephone call. One of the systems includes a base station wirelessly transmitting to an accessory device. The base station receives the telephone call via a communications network. The base station includes a transmitter transmitting only network-associated information to the accessory device. The network-associated information represents signaling within the communications network, and the network-associated information lies outside a voice-portion of the telephone call. The accessory device includes a receiver and a display, with the receiver receiving the network-associated information and the display presenting the network-associated information. When the telephone call is received, the accessory device presents the network-associated information to the subscriber, thus informing the subscriber of the network-associated information associated with the telephone call.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to telecommunications and, more particularly, to a transmitter and a separate call-alerting receiver.

2. Description of the Related Art

CallerID is a great service. CallerID, and other similarly-named services, display the calling telephone number and other listing information. When a telephone call is received, a subscriber may view this listing information before accepting the telephone call.

Telephones with this CallerID feature, however, have a common problem. A subscriber must locate the telephone before the listing information can be viewed. When a ring is heard, often times the subscriber scrambles to find the telephone. If the subscriber has an answering system, such as voicemail or an answering machine, the subscriber scrambles to find the phone before the preset number of rings activates the answering system. When the subscriber does locate the telephone, the subscriber is often frustrated at seeing the calling telephone number. The subscriber scrambled to find the telephone, only to discover the call is not desired. There is, accordingly, a need in the art for methods, systems, and devices for alerting a subscriber of the listing information associated with a telephone call, and a need for alerting the subscriber without first locating the telephone.

### BRIEF SUMMARY OF THE INVENTION

The aforementioned problems, and other problems, are reduced by methods, systems, and devices for alerting a subscriber to network-associated information associated with a telephone call. This invention allows a subscriber to view/hear listing information, and other information, associated with telephone calls. This listing information, however, may be viewed/heard without first locating a telephone. The system of this invention includes a base station and wireless, remote accessory device. When a telephone call is received, the base station wirelessly transmits only network-associated information associated with a telephone call to the accessory device. The accessory device then presents the network-associated information to the subscriber. This network-associated information may include the calling telephone number and any listing information associated with the calling telephone number. If the subscriber wishes to accept the telephone call, the subscriber may then locate the telephone. If the subscriber, however, wishes to ignore the telephone call, the subscriber can ignore the ring and allow the telephone call to forward to an answering system.

This invention also monitors the status of a telephone call. When the telephone call is received, the base station wirelessly transmits only the network-associated information to the accessory device. The accessory device may then continuously present the network-associated information. That is, the calling telephone number, any other listing information, and any other network-associated information, is continuously presented during the telephone call. Even if the telephone call is accepted, the accessory device continues to present the network-associated information during the telephone call. A parent, for example, may ignore the incoming telephone call when the calling party is a friend of a child's. Even though the child answers the telephone call, this invention allows the parent to monitor the telephone call. The parent not only knows the calling party, but the parent also knows the duration of the telephone call. The parent thus knows to whom the child talks and how long the child talks. If the parent does not recognize the calling telephone number, the continuously presented network-associated information can provide other information that helps the parent identify the calling party.

This invention offers similar advantages for originating calls. When a telephone call originates from the subscriber's residence/business, the subscriber can view the network-associated information associated with the outgoing telephone call. Using the parental example, when a child places a telephone call, the parent can view the called telephone number. If the parent does not recognize the called telephone number, the network-associated information can provide other information that helps the parent identify the called party (e.g., toll-free numbers, pay-per-minute numbers, payphones, and other revealing information). Because the network-associated information is continuously presented during the telephone call, the parent again knows the duration of the telephone call. The parent thus knows to whom the child talks and how long the child talks.

This invention discloses methods, systems, and devices for alerting a subscriber of network-associated information associated with a telephone call. One of the systems includes a base station wirelessly transmitting to an accessory device. The base station receives the telephone call via a communications network. The base station includes a transmitter transmitting only network-associated information to the accessory device. The network-associated information represents signaling within the communications network, and the network-associated information is outside a voice-band of the telephone call. The accessory device includes a receiver and a display. The receiver receives the network-associated information, and the display presents the network-associated information. When the telephone call is received, the accessory device presents the network-associated information to the subscriber, thus informing the subscriber of the network-associated information associated with the telephone call.

Another of the embodiments describes a method for alerting a subscriber of network-associated information associated with a telephone call. Here a telephone call is received at a base station. The telephone call comprises network-associated information representing signaling within the communications network, and the network-associated information lies outside a voice-band of the telephone call. The method wirelessly transmits only the network-associated information from a transmitter to an accessory device. The accessory device then presents the network-associated information on a display. The accessory device presents the network-associated information to the subscriber, thus informing the subscriber of the network-associated information associated with the telephone call.

Still more of the embodiments describe a device for alerting a subscriber of network-associated information associated with a telephone call. A receiver wirelessly receives network-associated information from a base station. The network-associated information represents signaling within the communications network, and the network-associated information is outside a voice-band of the telephone call. A display then presents the network-associated information, thus informing a subscriber of the network-associated information associated with the telephone call.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description of the Invention is read with reference to the accompanying drawings, wherein:

FIG. 1 is a schematic illustrating one of the embodiments of this invention for alerting a subscriber of network-associated information associated with a telephone call;

FIG. 2 is a block diagram of a base station shown in FIG. 1, according to the embodiments of this invention;

FIG. 3 is a block diagram of an accessory device shown in FIG. 1, according to more embodiments of this invention; and

FIG. 4 is a flowchart illustrating a method for alerting a subscriber of network-associated information associated with a telephone call, according to the embodiments of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

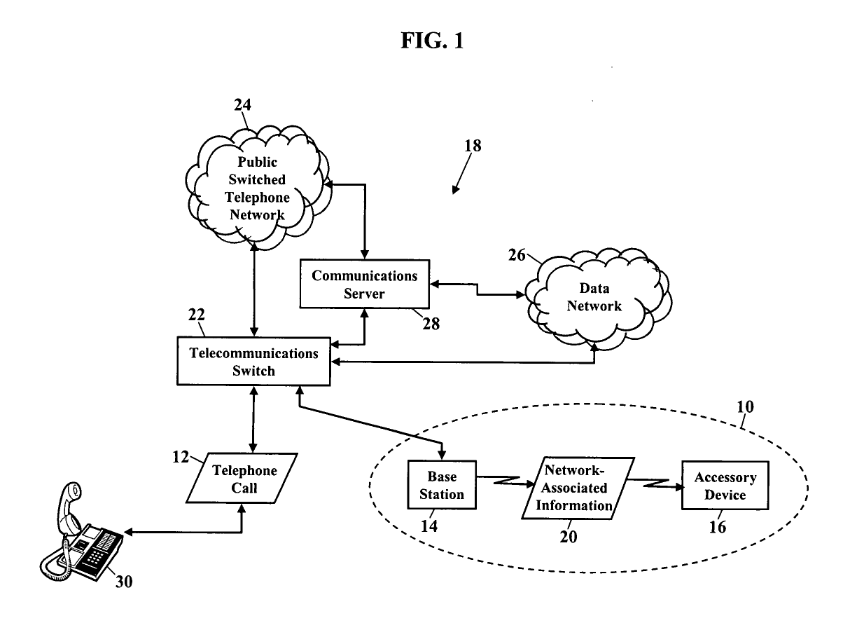

FIG. 1 is a schematic illustrating one of the embodiments of this invention. FIG. 1 shows a system 10 for alerting a subscriber of network-associated information associated with a telephone call 12. The system 10 comprises a base station 14 and a wireless accessory device 16. When the base station 14 receives the telephone call 12 via a communications network 18, the base station 14 wirelessly communicates network-associated information 20 to the accessory device 16. As this patent will explain, the network-associated information 20 comprises “out of band” signaling from the communications network 18. That is, the network-associated information 20 comprises signaling messages communicated within the communications network 18, and these signaling messages lie outside the voice band of the telephone call 12. When the accessory device 16 receives the network-associated information 20, the accessory device 16 presents the network-associated information 20 to a subscriber. The subscriber is thus informed of the network-associated information 20 associated with the telephone call 12.

FIG. 1 shows the communications network 18. The communications network 18 may include an intelligently-controlled telecommunications switch 22 receiving voice and/or data signals from the Public Switched Telephone Network 24 and/or from a data network 26. The telecommunications switch 22 includes a communications server 28 controlling many features of the telecommunications switch 22. The communications server 28, for example, may include Advanced Intelligent Network (AIN) componentry. If, however, the telecommunications switch 22 operates as a packet-based “softswitch,” then the communications server 28 uses software control to provide voice, data, and video services by dynamically changing connection data rates and protocols types. The signaling between the telecommunications switch 22, the Public Switched Telephone Network 24, the communications server 28, and the data network 26, however, is well understood in the art and will not be further described. If a reader desires a more detailed explanation, the reader is directed to U.S. Pat. No. 5,430,719 issued to Weisser (Jul. 4, 1995), with the “Summary of the Invention” and the “Detailed Description of the Preferred Embodiment” sections incorporated herein by reference. The reader is also directed to U.S. Pat. No. 5,917,817 issued to Dunn et al. (Jun. 29, 1999), with the “Summary of the Invention” and the “Detailed Description” sections incorporated herein by reference. As those of ordinary skill in the art also understand, if the telecommunications switch 22 operates as a packet-based “softswitch,” then the communications server 28 interfaces with the telecommunications switch 22 via a packet protocol, such as Session Initiation Protocol (SIP). The communications server 28 includes voice service protocols, triggers, and operations that allow the Public Switched Telephone Network 24 and the data network 26 to interoperate.

The system 10 alerts a subscriber of the network-associated information 20 associated with the telephone call 12. The base station 14 receives the telephone call 12 via the communications network 18. If the telephone call 12 is a plain-old telephone call, the telephone call 12 comprises both voice signals and data signals. That is, the telephone call 12 comprises voice-band signals and “out of band” data signals. These “out of band” data signals include the network-associated information 20 that accompanies the telephone call 12. If the telephone call 12 has a voice-over Internet Protocol (“Voice-over-IP”) structure, the telephone call 12 comprises packets of information communicated according to various packet protocols. These packets of information include both voice packets and data packets, and the data packets represent the network-associated information 20 that accompanies the telephone call 12. Whatever the structure of the telephone call 12, the base station 14 receives the telephone call 12 via the communications network 18. The base station 14 then filters/discards the voice portion from the network-associated information 20. The base station 14 then wirelessly transmits only the network-associated information 20 to the accessory device 16. That is, the base station 14 transmits the network-associated information 20 without transmitting, or independent of, the voice portion of the telephone call 12. The accessory device 16, then, only wirelessly receives the network-associated information 20. The accessory device 16 does not receive the voice portion of the telephone call 12, regardless of whether the telephone call 12 comprises voice-band signals and/or voice packets.

The accessory device 16 receives the network-associated information 20. The accessory device 16 then presents the network-associated information 20 to a subscriber. The network-associated information 20 may be visually-presented and/or audibly presented. When the telephone call 12 is received, the accessory device 16 thus informs the subscriber of the network-associated information 20 associated with the telephone call 12. The subscriber may then accept the telephone call 12 by causing a telephonic device 30 to go off-hook.

The network-associated information 20 is independent of the voice portion of the telephone call 12. The network-associated information 20 is/are signals and/or messages that accompany the telephone call 12. The network-associated information 20 may include an incoming calling line identification (ICLID) signal. This ICLID signal identifies the calling telephone number. The ICLID signal may also identify a name and/or address associated with the calling telephone number (commonly referred to as “listing information”). The network-associated information 20, however, may also include information digits associated with the ICLID signal. These information digits describe whether the call is a local call or a long-distance call, any access code for a service provider, and the type of calling station/terminal (e.g., coin-operated phone, non-coin-operated phone, dual-tone modal frequency phone, rotary-dial phone, prison phone). The information digits may also describe coding that blocks the delivery of the ICLID service. The network-associated information 20 may also include telephone call handling messages/information, telephone call routing messages/information, the duration of the telephone call 12, and the time the telephone call was placed/received. The network-associated information 20 may also include signaling messages, such as SS7 messages within the communications network 18.

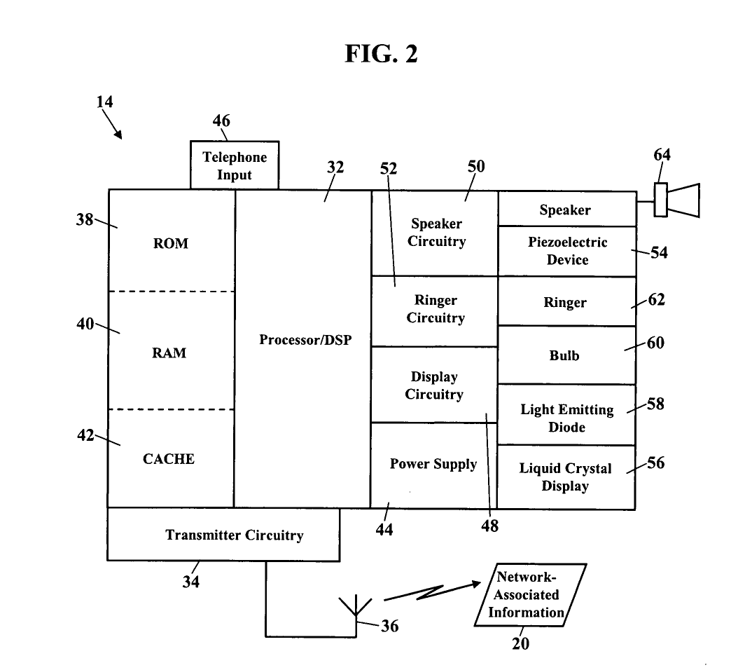

FIG. 2 is a block diagram of the base station 14. The base station 14 comprises a processor 32 and a transmitter 34. An antenna 36 couples to the transmitter 34 and converts electromagnetic waves to current. The processor 32 controls the transmitter 34, and the processor 32 may also perform signal processing functions for electromagnetic signals of any desired frequency within the electromagnetic spectrum. Various memory devices, such as Read-Only Memory (ROM) 38, Random-Access Memory (RAM) 40, and cache memory 42, store instructions, software programming, and the network-associated information 20. A power supply 44 (such as an AC power supply and/or a battery) provides an electrical power source for the processor 32 and the transmitter 34. The base station may also include a telephone input 46 for receiving the telephone call 12. This telephone input 46 is typically a modular jack for connection of a telephone line (neither shown for simplicity), although the base station 14 itself may wirelessly receive the telephone call 12. As FIG. 2 shows, the base station 14 may include display circuitry 48, speaker circuitry 50, ringer circuitry 52, and/or a piezoelectric device 54. When the base station 14 receives the telephone call 12, the processor 32 may command the display circuitry 48, the speaker circuitry 50, the ringer circuitry 52, and/or the piezoelectric device 54 to alert the subscriber of the incoming telephone call 12. That is, the display circuitry 48 may cause a liquid crystal display 56 to flash a message/light, a light-emitting diode 58 to activate, and/or a bulb 60 to activate. The ringer circuitry 52 could cause a ringer 62 to activate, and the speaker circuitry 50 may cause a speaker 64 to emit sounds. The display circuitry 48, the speaker circuitry 50, the ringer circuitry 52, and/or the piezoelectric device 54 alert the subscriber of the incoming telephone call 12. As those of ordinary skill in the art understand, the display circuitry 48 may additionally or alternatively activate other display devices, such as flat-panel displays, cathode ray devices, and plasma devices.

The base station 14 wirelessly communicates the network-associated information 20. The network-associated information 20 comprises signaling messages that lie outside the voice band of the telephone call 12 and/or that do not include voice information/signals. When the base station 14 receives the telephone call 12, the base station 14 filters/discards the voice portion from the network-associated information 20. The base station 14 then wirelessly transmits only the network-associated information 20 to the accessory device (shown as reference numeral 16 in FIG. 1). That is, the base station 14 transmits the network-associated information 20 without transmitting, or independent of, the voice portion of the telephone call 12.

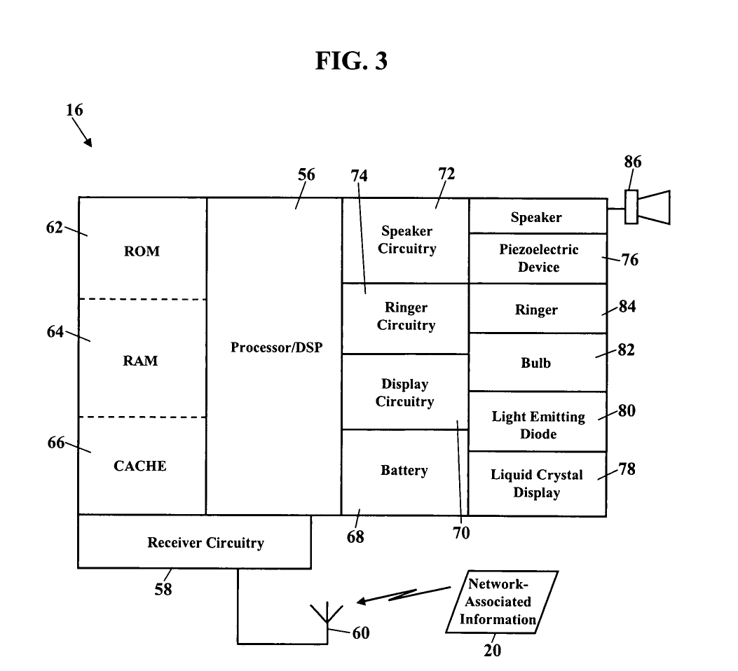

FIG. 3 is a block diagram of the accessory device 16. The accessory device 16 receives the wirelessly transmitted network-associated information 20 associated with the call (shown as reference numeral 12 in FIGS. 1 and 2). The accessory device 16 comprises a processor 56 and a receiver 58. An antenna 60 couples to the receiver 58 and converts electromagnetic waves to current. The processor 56 controls the receiver 58, and the processor 56 may perform signal processing functions for electromagnetic signals of any desired frequency within the electromagnetic spectrum. Various memory devices, such as Read-Only Memory (ROM) 62, Random-Access Memory (RAM) 64, and cache memory 66, store instructions, software programming, and the network-associated information 20. A battery 68 provides an electrical power source for the processor 56 and the receiver 58. The accessory device 16 may include display circuitry 70, speaker circuitry 72, ringer circuitry 74, and/or a piezoelectric device 76. When the accessory device 16 receives the network-associated information 20, the processor 56 may command the display circuitry 70, the speaker circuitry 72, the ringer circuitry 74, and/or the piezoelectric device 76 to alert the subscriber of the incoming network-associated information 20. That is, the display circuitry 70 may cause a liquid crystal display 78 to flash a message/light, a light-emitting diode 80 to activate, and/or a bulb 82 to activate. The ringer circuitry 74 could cause a ringer 84 to activate, and the speaker circuitry 72 may cause a speaker 86 to emit sounds. The piezoelectric device 76 may alert the subscriber by buzzing and/or by producing a tactile alert, such as a vibration or vibrating motion. The display circuitry 70, the speaker circuitry 72, the ringer circuitry 74, and/or the piezoelectric device 76 alert the subscriber of the incoming network-associated information 20. As those of ordinary skill in the art understand, the display circuitry 70 may additionally or alternatively activate other display devices, such as flat-panel displays, cathode ray devices, and plasma devices.

The accessory device 16 also displays the network-associated information 20. When the receiver 58 receives the wirelessly transmitted network-associated information 20, the processor 56 commands the display circuitry 70 to present the network-associated information 20. The display circuitry 70, for example, presents the incoming calling line identification (ICLID) signal associated with the incoming telephone call. This ICLID signal identifies the calling telephone number, a name, and/or an address associated with the calling telephone number. The display circuitry 70 may also present the information digits associated with the ICLID signal, thus identifying many characteristics/features/attributes of the calling station/terminal. The display circuitry 70, for example, may present the information digits associated with a local or long-distance call, any access code for a service provider, and/or the type of calling station/terminal (e.g., coin-operated phone, non-coin-operated phone, dual-tone modal frequency phone, rotary-dial phone, prison phone). The information digits may also describe coding that blocks the delivery of the ICLID service, thus informing the subscriber that the calling party has “blocked” the ICLID signal. The display circuitry 70 may also present telephone call handling messages/information, telephone call routing messages/information, the duration of the telephone call, and the time the telephone call was placed/received. The display circuitry 70 may also present signaling messages, such as SS7 messages.

The accessory device 16 preferably continuously displays the network-associated information 20. When the receiver 58 receives the wirelessly transmitted network-associated information 20, the processor 56 commands the display circuitry 70 to present the network-associated information 20. The accessory device 16 of this invention continuously presents the network-associated information 20 during the telephone call (shown as reference numeral 12 in FIGS. 1 and 2). Not only is the network-associated information 20 presented upon receipt, but the network-associated information 20 is presented even after the telephone call is answered. The accessory device 16 of this invention continuously presents the network-associated information 20 until an on-hook condition is detected. Because the network-associated information 20 is continuously presented, the accessory device 16 informs the subscriber of the calling telephone number and any listing information associated with the calling telephone number. The network-associated information 20 also informs the subscriber of the duration of the telephone call and any information digits associated with the calling telephone number. The accessory device 16, for example, allows a parent to know when telephone calls are received, the identity of the calling party, and even the duration of the telephone call.

The processors 32 and 56 may be a digital signal processor (DSP) and/or a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Texas Instruments offers a wide variety of digital signal processors (Texas Instruments, Incorporated, P.O. Box 660199, Dallas, Tex. 75266-0199, Phone: 972-995-2011, www.ti.com) as well as Motorola (Motorola, Incorporated, 1303 E. Algonquin Road, Schaumburg, Ill. 60196, Phone 847-576-5000, www.motorola.com). Those of ordinary skill in the art understand that this invention is not limited to any particular manufacturer's processor.

The accessory device 16 may be programmed to selectively alert of the network-associated information 20. When the accessory device 16 receives the network-associated information 20, the processor 56 commands the display circuitry 70, the speaker circuitry 72, the ringer circuitry 74, and/or the piezoelectric device 76 to alert the subscriber of the incoming network-associated information 20. The accessory device 16, however, may be programmed to only alert the subscriber when selected network-associated information 20 is wirelessly received. The various memory devices (the Read-Only Memory 62, the Random-Access Memory 64, and the cache memory 66) could store subscriber-specified information. When the accessory device 16 receives the network-associated information 20, the processor 56 compares the wirelessly received network-associated information 20 to the stored subscriber-specified information. If the processor 56 finds a match, the processor 56 then executes any stored instructions. The accessory device 16 may thus be programmed to alert, or to not alert, upon receipt of matching network-associated information 20. The subscriber, for example might store selected telephone numbers in memory. If the wirelessly received ICLID signal matches one of the selected telephone numbers stored in memory, only then would the accessory device 16 alert the subscriber. The subscriber, for example, might only want to be alerted when the telephone call is from a relative, friend, or other desired party. If a match is found, conversely, the accessory device 16 might be programmed to not alert the subscriber and, thus, screen incoming telephone calls. If the ICLID signal is blocked by the calling party, the accessory device 16 could be programmed to not alert the subscriber. The accessory device 16, similarly, may be programmed to not alert the subscriber if the network-associated information 20 is associated with a certain area code, a toll-free number, pay phones, and/or collect calls. The accessory device 16, similarly, may be programmed to not alert the subscriber if the network-associated information 20 shows the call is placed/received during specified hours/days (such as sleeping hours, dinner time, holidays, weekends, or appointments).

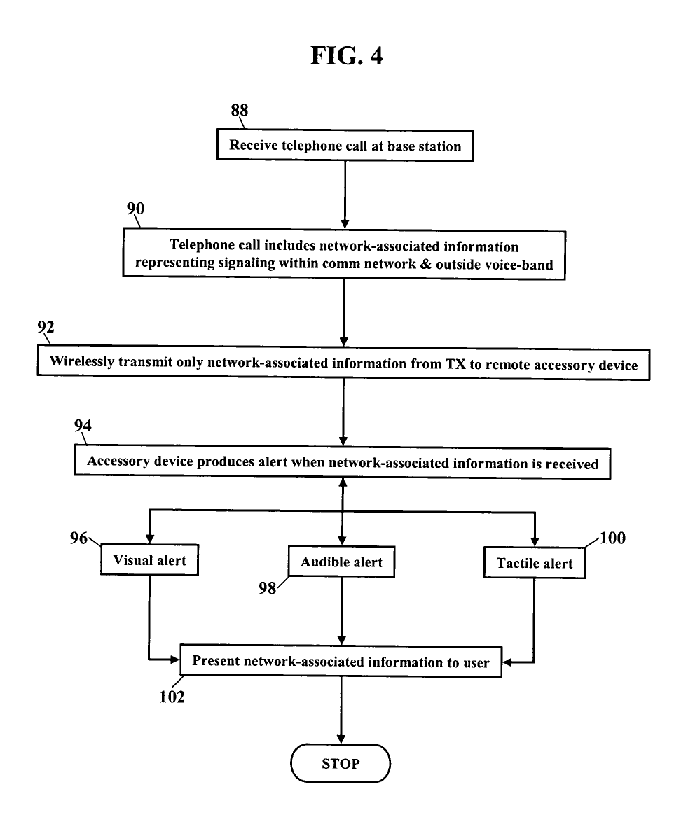

FIG. 4 is a flowchart illustrating a method for alerting a subscriber of network-associated information associated with a telephone call. A telephone call is received at a base station (Block 88). The telephone call includes network-associated information representing signaling within the communications network, the network-associated information outside a voice-band of the telephone call (Block 90). Only the network-associated information is wirelessly transmitted from a transmitter (TX) to a remote accessory device (Block 92). When the network-associated information is received, the remote accessory device produces an alert (Block 94). The alert may be visual (Block 96), audible (Block 98), and/or tactile (Block 100). The network-associated information is then presented to the subscriber (Block 102). The method thus alerts the subscriber to the network-associated information associated with the telephone call.

This invention offers similar advantages for originating calls. When a telephone call originates from the subscriber's residence/business, the subscriber can view network-associated information associated with the outgoing telephone call. The base station 14 can wirelessly transmit the called telephone number to the accessory device 16. The base station 14 can also wirelessly transmit other network-associated information associated with the outgoing telephone call. As the telephone call is processed by the communications network 18, the communications network 18 communicates the network-associated information 20 to the base station 14. The base station 14 can itself present this network-associated information 20. The base station 14 may also wirelessly transmit the network-associated information 20 to the accessory device 16. The subscriber is thus able to monitor originating telephone calls.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A system for alerting a subscriber of network-associated information upon receipt of a telephone call, the system comprising:
a base station wirelessly transmitting to an accessory device;
the base station receiving the telephone call via a communications network, the base station including a transmitter transmitting only network-associated information to the accessory device, the network-associated information representing signaling within the communications network, the network-associated information outside a voice portion of the telephone call; and
the accessory device including a receiver and a display, the receiver receiving the network-associated information and the display presenting the network-associated information,
wherein when the telephone call is received, the accessory device presents the network-associated information to the subscriber, thus informing the subscriber of the network-associated information associated with the telephone call.

2. A system according to claim 1, the accessory device further comprising circuitry producing an alerting signal upon activation.

3. A system according to claim 2, wherein the alerting signal is at least one of visual, audible, and tactile.

4. A system according to claim 1, wherein the accessory device further comprises circuitry producing an alerting signal, the signal alerting the subscriber of receipt of the network-associated information.

5. A system according to claim 1, wherein the accessory device continuously presents the network-associated information during the telephone call.

6. A system according to claim 1, wherein the accessory device continuously presents the network-associated information until an on-hook condition is detected.

7. A system according to claim 1, wherein the network-associated information includes an incoming calling line identification (ICLID) signal.

8. A method for alerting a subscriber of network-associated information associated with a telephone call, the method comprising:
receiving a telephone call at a base station, the telephone call comprising network-associated information representing signaling within the communications network, the network-associated information outside a voice portion of the telephone call;
wirelessly transmitting only the network-associated information from a transmitter to an accessory device; and
presenting the network-associated information to the subscriber,
wherein the subscriber is alerted to the network-associated information associated with the telephone call.

9. A method according to claim 8, further comprising producing an alerting signal upon receipt of the network-associated information.

10. A method according to claim 8, further comprising producing a visual alerting signal upon receipt of the network-associated information.

11. A method according to claim 8, further comprising producing an audible alerting signal upon receipt of the network-associated information.

12. A method according to claim 8, further comprising producing a tactile alerting signal upon receipt of the network-associated information.

13. A device for alerting a subscriber of network-associated information associated with a telephone call, the device comprising:
a receiver wirelessly receiving network-associated information from a base station, the network-associated information representing signaling within the communications network, the network-associated information outside a voice portion of the telephone call; and
a display presenting the network-associated information,
wherein when the network-associated information is received, the device presents the network-associated information to the subscriber, thus informing the subscriber of the network-associated information associated with the telephone call.

14. A device according to claim 13, the device further comprising circuitry producing an alerting signal upon activation.

15. A device according to claim 14, wherein the alerting signal is at least one of visual, audible, and tactile.

16. A device according to claim 13, wherein the device continuously presents the network-associated information during the telephone call.
